(19) United States
(12) Patent Application Publication
(10) Pub. No.: US 2013/0197970 A1
(43) Pub. Date: Aug. 1, 2013

(54) SOCIAL NETWORK ANALYSIS FOR USE IN A BUSINESS

(71) Applicants: Michael Aaskov, Dubai (AE); Mark S. Ramsey, Kihei, HI (US); David A. Selby, Hants (GB)

(72) Inventors: Michael Aaskov, Dubai (AE); Mark S. Ramsey, Kihei, HI (US); David A. Selby, Hants (GB)

(73) Assignee: INTERNATIONAL BUSINESS MACHINES CORPORATION, Armonk, NY (US)

(21) Appl. No.: 13/360,848

(22) Filed: Jan. 30, 2012

(51) Int. Cl. G06Q 30/02

(52) U.S. Cl. 705/7.31

(57) ABSTRACT

A historical analysis is performed within peer groups within a population such as associates of business or organization in regard to a plurality of factors having a possible bearing on satisfaction of individual members of the population in regard to the environment of the population to determine members of the population that may be likely candidates to be responsive to encouragement and/or incentives toward improved performance. The historical analysis is preferably supplemented by repeating of the scoring aspect of the historical analysis and comparison of current scores with previous scores to provide substantially real-time information and to allow detection of trends. The results of the historical analysis and/or the prospective analysis are overlaid with results of social network analysis within the population to project a spread of influences within the population.

### FIELD OF THE INVENTION

The present invention generally relates to the use of social networks within a business and, more particularly, to application of social network analysis to improvement associate productivity and satisfaction.

### BACKGROUND OF THE INVENTION

A traditional approach to monitoring the general state of satisfaction of those associated with a business has only been to use static and infrequent surveys which also carry substantial expense and are of very questionable reliability. Responses to such surveys are very likely to be biased by the apparently probable response that an individual perceives would be preferred by the business, particularly if the survey is not performed under assurances of being conducted anonymously. On the other hand, a survey conducted anonymously will lose information in regard to the satisfaction level of specific individuals that the business may be able to address.

These approaches have very low value in providing real-time understanding of associate satisfaction or addressing potential issues of changes in satisfaction at an early date when action may be more effective in achieving improved productivity. The problem is further complicated by the fact that the obtaining of information by the business that may support improvement in conditions and increase of satisfaction may be deemed to be intrusive and a direct detriment to job satisfaction.

Additionally, there may be additional social factors that affect associate satisfaction. It is to be expected that a high level of collegiality, friendship and empathy among closely associated individuals should increase satisfaction. Similarly, satisfaction with some aspects of business circumstances may be spread among individuals that are associated with each other.

### SUMMARY OF THE INVENTION

It is therefore an object of the present invention to provide a methodology and monitoring apparatus to provide a real-time increased understanding of associate satisfaction through a combination of behavioral analytics, deviation detection and social network analysis.

It is another object of the invention to provide a management tool with a real-time satisfaction evaluation system.

In order to accomplish these and other objects of the invention, a method is provided of evaluating likelihood, within a population of persons, that members of said population will respond to encouragement or incentives comprising steps of identifying a plurality of peer groups within the population selected to have similar responses to each of a plurality of factors common to the population, evaluating members of respective peer groups in regard to respective factors to obtain a baseline or distribution, scoring members of the peer group based on the location of the evaluation of a member of a peer group relative to said baseline or distribution for the factors within the peer group to form peer group member scores, and combining the group member scores and determining likelihood of responsiveness to encouragement or incentives from scores significantly higher or lower than an average or median of group member scores within the peer group, including configuring a computer to perform such steps. The result of such analysis is preferably refined by performing a prospective analysis by repeating the scoring process and comparing current scores for individuals with previous scores for individuals and projecting a spread of influences within the population by overlaying results of the historical analysis and/or the prospective analysis with results of a social network analysis of the population.

### BRIEF DESCRIPTION OF THE DRAWINGS

The foregoing and other objects, aspects and advantages will be better understood from the following detailed description of a preferred embodiment of the invention with reference to the drawings, in which:

FIG. 1 is a high-level schematic or data flow diagram of a preferred embodiment of the invention, and

FIG. 2 is a graph of a distribution of data for a peer group of associates in regard to a satisfaction factor or indicator that may be useful in conveying an understanding of the methodology of the invention.

### DETAILED DESCRIPTION OF A PREFERRED EMBODIMENT OF THE INVENTION

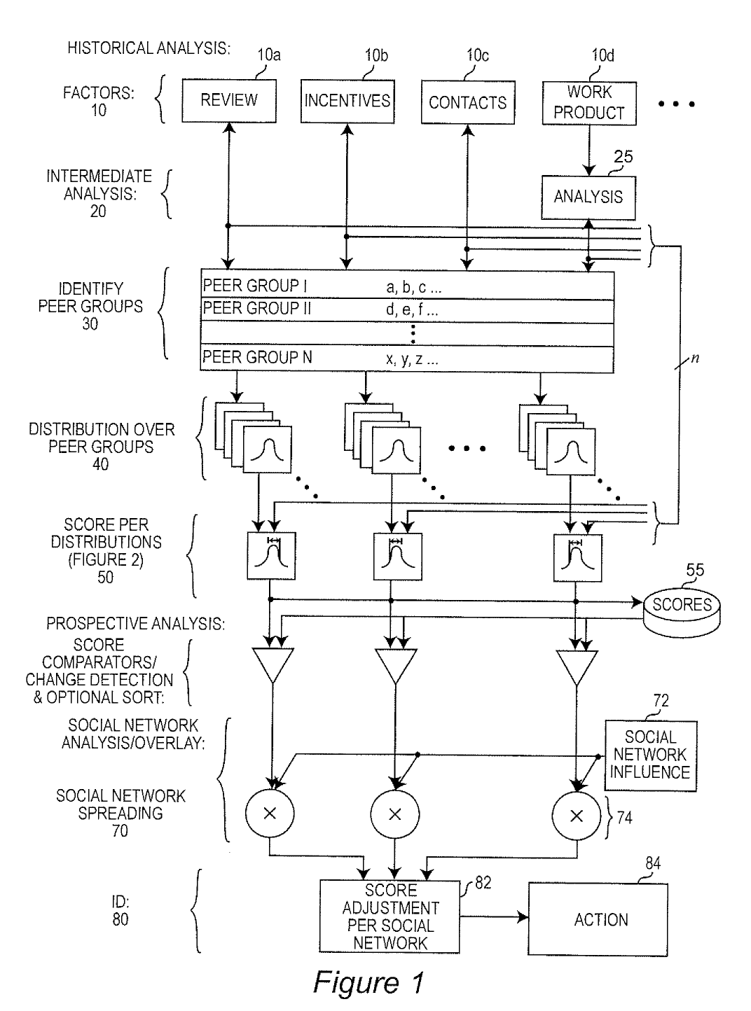

Referring now to the drawings, and more particularly to FIG. 1, there is shown a high-level schematic diagram of the architecture of a preferred embodiment of the present invention. FIG. 1 is also arranged in a manner such that it can be understood as a flow chart of the methodology of the invention.

As a general overview, prior to a detailed discussion of the invention, the present invention is comprised of two principal analysis components, in combination: a historical analysis supplemented and leveraged by a prospective analysis based on outlier detection and scoring that can be carried out on a real-time basis and a social network analysis that serves to project a quantitative portion of a (sufficiently positive or negative) satisfaction score of interest on social network cohorts.

The historical analysis is performed over a group of individuals and provides a quantitative statistical distribution of behaviors of individual members of the group in regard to attributes of circumstances that may have a bearing on satisfaction. A satisfaction score for individuals can thus be derived based on variance from a statistical average or mean of individual behaviors. A preferred algorithm for performing this technique is provided in U. S. Published Patent application 2009/0228233A1 which is hereby fully incorporated by reference although other algorithms may be suitable and can be used in the successful practice of the present invention. In any case, such a methodology and the results thereof become far more meaningful when performed over a peer group of individuals that appear likely to exhibit changes in behaviors which are similar to each other in response to particular events or changes in business or individual circumstances, as is preferred in the practice of the invention. Choice of such a peer group (e.g. mechanical engineers, electrical engineers, analysts, support personnel, clerical personnel, etc., possibly also limited to distinct operations of the business) tends, on the one hand, to stabilize the distributions of behaviors as the historical analysis is performed and the results updated from time to time and, on the other hand, selection of such peer groups tends to make the distribution of behaviors more nearly conformal to a standard distribution curve which simplifies the computation of individual satisfaction scores and provides an increased level of confidence in the results of the scoring process, as will be discussed in greater detail below.

Prospective analysis is essentially a substantially real-time repetition and updating of the scoring process for individuals in particular peer groups based on the information derived by the historical analysis and detection of changes in individual satisfaction scores that may provide an indication of an opportunity for providing support and/or encouragement that may lead an associate to higher levels of creativity and/or productivity. Significance of magnitude of any score change can be determined empirically in regard to any and all behaviors that may be tracked in the historical analysis.

It should be appreciated that historical analysis can, itself, provide valuable insight into satisfaction at the time it is performed sufficient to support intervention in the case of high (and possibly low) scores that significantly deviate from the average or mean score for one or more satisfaction factors within a peer group at and shortly after the historical analysis is performed. The prospective analysis provides a supplement to the historical analysis in that it can be repeated frequently with a relatively low computational burden to detect changes that may correlate with particular events or subtle changes in the environment of the associate of a peer group. A frequently repeated prospective analysis can also detect trends for individuals and trends for changes in satisfaction levels between peer groups. Such types of changes in satisfaction level could also be detected by repetitions of the historical analysis but with increased granularity (due to less frequent repetition as practicality dictates) and computational burden.

Finally, social network analysis within the business is performed and overlaid on the results of the prospective analysis to project potential influence of one associate that exhibits a score change on others with whom the associate may be in frequent social contact. That is, if a given individual exhibits a potential opportunity for improved performance, others with whom the individual may be more or less closely associated may exhibit some degree of similar opportunity.

More specifically, as illustrated in FIG. 1, a number of factors 10 that may have a bearing on or be directly or indirectly indicative of attributes of associate satisfaction and for which, information is available or can be developed are identified. Such factors should generally include factors such as the length of time since the last performance review and the results of that review (e.g. collectively indicated at 10a but which may be separately analyzed), the number of times and frequency of instances the associate has qualified for incentives, the nature of the incentives and the appropriateness of the incentive(s) to the associate's circumstances in view of the benefit to the business (e.g. collectively indicated at 10b but which may be separately analyzed), the number, nature and frequency of contacts with support personnel (e.g. collectively indicated at 10c but which may be separately analyzed) and various aspects of the associate's work product such as number and frequency of expense claims, use of leave, shortness of deadlines, aspects of collaboration with others and the like which are also collectively indicated at 10d but which are preferably analyzed separately. These factors are not limited to those indicated above or for which data is ordinarily collected but may extend to information which can be derived from other information available, such as the content of intramural communications, which, like many of the work product factors, may be subjected to intermediate (e.g. semantic) analysis 20, as indicated at 25, in order to derive information of suitable relevance to satisfaction or having an empirically or statistically determined linkage to likelihood of responsiveness to encouragement or incentives.

As alluded to above, it is desirable to perform analysis of these factors in regard to peer groups that are chosen based on a likelihood of having similar responses to such factors. For example, one (or more) peer groups might be entirely or predominantly electrical engineers while one (or more) other peer groups may be entirely or predominantly mechanical engineers while yet other peer groups may be predominantly from one or more support, design, marketing, information management and the like groups. It is considered to be preferable that these peer groups be selected from across the entire population of associates of the business and not limited within, for example, a particular project or product production area because the social network analysis which will be overlaid upon the result of the historical and prospective analyses, as will be described in detail below, will account for interactions within such specific operations and events within such specific operations may tend to skew and/or reduce stability of statistical distributions of data in regard to the satisfaction indicator factors 10 discussed above as compared with peer groups selected from across the entire business on the basis of similarity of likely response to conditions or events. It is also more likely that the results of analysis of satisfaction indicator factors will conform to a standard (e.g. Gaussian) distribution if peer groups are chosen across the entire population of the business.

It is desirable that the peer groups be large enough that the statistical distribution of value of particular factors for the peer group to be substantially unaffected by changes in one or more satisfaction factors for any individual. It is not required that an individual be a member of only a single peer group and an individual may be included in more than one peer group or even divided between one or more peer groups (e.g. on a weighted basis).

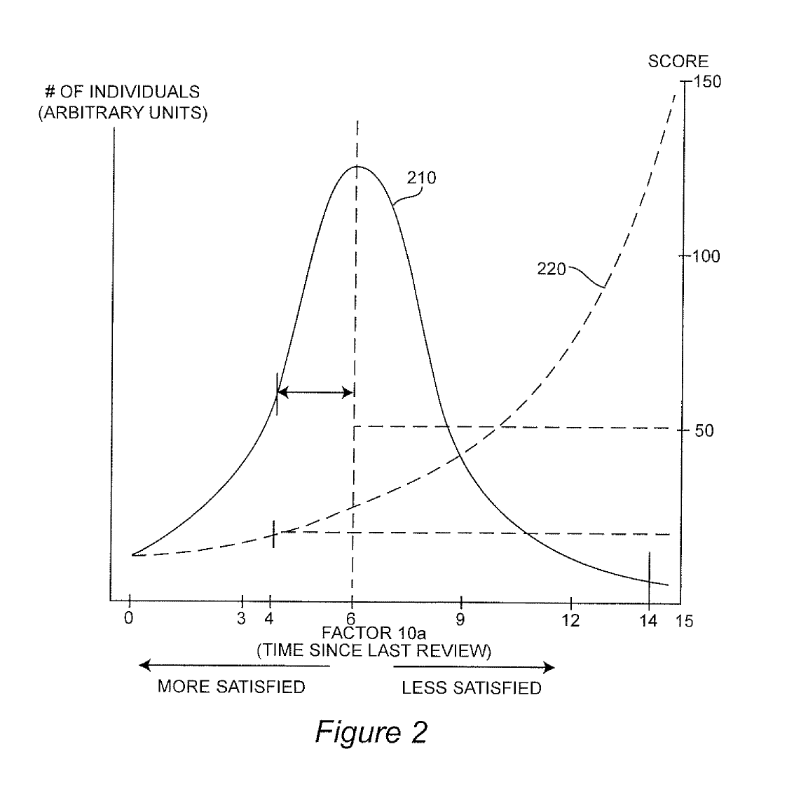

Once the peer groups have been determined, as indicated at 30 of FIG. 1, an evaluation of each individual is performed in regard to all or selected satisfaction indicator factors 10 and statistical distributions of the data are determined across each peer group as depicted at 40 of FIG. 1. It should be understood that each group may have distributions determined in regard to all individual factors or, in some peer groups, some factors may be associated within a given satisfaction indicator factor or one or more satisfaction indicator factors may be omitted altogether in the analyses for some peer groups. An exemplary standard distribution in regard to factor 10a, time since last review, is illustrated in FIG. 2. The horizontal axis of FIG. 2 is scaled in accordance with the nature of the factor. For example, if the business policy provides for annual performance reviews, the average or mean time since the most recent performance review for any given individual would be likely to be approximately six months, as illustrated for the peak of the standard distribution curve. The vertical axis is the number of associates in the peer group having a given time durations since the most recent performance review (in arbitrary units) as shown at the left side of FIG. 2. The standard distribution curve 210 is ideally symmetric although, as shown, the “tail” of the curve may be truncated in accordance with the nature of the factor. In this case, the time since the last performance review cannot be less than zero months but that period could, in theory, be extended indefinitely (to the right-hand side of FIG. 2. While it is preferable to use an ideal standard distribution curve, a curve developed based on the actual distribution of quantitative values of a given factor could also be used. For example, if performance reviews are late for most associates in a given peer group (e.g. an average or median time of eight months), the satisfaction of an individual due to that factor might be very much reduced and the standard or actual distribution curve 210 would be shifted to the right relative to scoring curve 220 and may be differently shaped.

As also illustrated in FIG. 2, a scoring function 220 is also provided in accordance with the standard distribution curve 210. This scoring function can be substantially arbitrary but is preferably based on empirical data which correlates likelihood of improved performance with the quantitative value of each factor. An exemplary score for a given factor is illustrated in a scale at the right-hand side of FIG. 2. In this case, the score for the average or median value is set at an exemplary numerical value of 50 but the score value assigned to the average or median value is not important to the successful practice of the invention other than for establishing a scale and weight for each individual associate value for that factor. The score value at the average or median value of the factor can also be set to simplify the computation of an aggregate score for the associate across a plurality of factors. For example, if ten factors are to be considered in the historical analysis, a score of 50 for the average or median would produce a score of 500 by simple summing of the individual factor scores for an associate whose satisfaction indicator factors were evaluated to precisely equal the average or median of the peer group while being likely to generate composite satisfaction scores that are usually in the range of 0 to 1000 or some other numerical range providing sufficient resolution to differentiate associates. Other scaling arrangements and criteria can also be used as may prove to be convenient.

Using the distribution curve 210 and scoring curve 220 for each factor for each peer group, a composite satisfaction score is developed for each associate as depicted at 50 of FIG. 1. In this exemplary case for time since the most recent performance review for an associate and having an average or median value of six months, an associate having had a performance review within the last four months would be assigned a low score (e.g. about 20) for this factor whereas an associate having waited for a performance review for fourteen months, a time in excess of the established policy of the business, would be assigned a high (and possibly disproportionate) score of about 140 for this factor. The scores for the respective factors for each associate in each peer group are then optionally combined into a composite satisfaction score for each associate and the result stored in memory 55. Optionally but preferably, the individual factor scores for each individual associate are also stored with the composite score and may be used for determining particular factors to be addressed in some action to improve satisfaction.

It should be appreciated that the historical analysis described above is capable of providing substantially improved information about satisfaction than has been available prior to the present invention. That is, extreme composite or individual factor scores (e.g. in the upper or lower quartile of all scores in a peer group or across the population of all or a significant portion of associates of the business) are themselves relatively reliable indicators of likely candidates for having performance improvement potential whenever the historical analysis is repeated or updated, particularly when leveraged by overlaying social network analysis thereon as will be disclosed below. However, the results may be somewhat generalized and may not be adequately timely or sensitive to current conditions and events within the business. Therefore, in accordance with the invention, it is preferred to leverage the historical analysis described above with a prospective analysis which will now be described with further reference to FIG. 1.

The prospective analysis provided in accordance with the invention is intended to leverage the historical analysis in accordance with the invention as described above to provide near-real-time information. This further analysis is prospective or predictive in the sense that there will generally be a time lag between the event or change in circumstances that may cause a change in satisfaction and an actual change in the satisfaction level of a given associate. Therefore, prospective analysis provides a good and timely predictor of individuals who may become good candidates for improved performance upon suitable encouragement.

The prospective analysis 60 provided by the invention is quite simple and can be rapidly performed based on data developed during the historical analysis discussed above. Simply put, on a relatively frequent or event driven basis, the individual satisfaction indication factor scores and the composite satisfaction score (but not the distributions for factors within peer groups) are re-computed and updated in the manner discussed above for all or a group of associate and the results compared to the score results previously computed and stored as illustrated at 60 of FIG. 1, allowing changes in scores and the magnitude of the change to be readily detected. Detected changes in scores can then be sorted by magnitude to determine individuals for whom early intervention or remedial action may be most likely to be productive together with an identification of the factors of greater apparent importance to the individual for development of the particular actions to be employed in the intervention.

Additionally, the inventors have recognized that the influence of other associates is likely to be of substantial importance in regard to any particular action taken or contemplated by an individual. Accordingly, as illustrated at 70 of FIG. 1, social analysis 72 of the population of business associates or a selected portion thereof is preferably performed to determine which associates are likely to influence others in regard to performance and an indication of how likely a given associate is to be influenced by another. Numerous methodologies of social network analysis are known and/or foreseeable, such as analysis of e-mail traffic between particular associates. Overlaying the result of social analysis on the result of either historical analysis and/or prospective analysis as described above such as by multiplying individual factor and/or composite scores for the “influencer” and “follower”, as determined by the social network analysis thus provides not only an indication of the spread of any particular satisfaction among associates but also accounts for cascading of effects having a bearing on satisfaction among associates. That is, a first associate may become more satisfied due to one event while a second associate may become more satisfied due to another factor or particular event but that increase in satisfaction may be augmented by the increase in satisfaction of the first associate even though the event or circumstance causing increased satisfaction of the first associate may be a matter of complete indifference to the second associate. It should be understood that the overlay of social analysis results can also be directly applied to the results of the historical analysis as discussed above with substantially the same effects of projecting the likelihood of responsiveness to encouragement or incentives through the population.

The resulting scores as modified by the information from social network analysis as illustrated at 82 can then be evaluated and, optionally, sorted by magnitude to identify individuals and groups that are candidates for some action, as illustrated at 80 of FIG. 1. Again, the particular sources of changes in satisfaction can be determined by the contributions of changes in individual factors to the change in the composite score for individual associates, as illustrated at 84.

In view of the foregoing, it is seen that the invention provides a system and methodology for identifying individuals whose satisfaction is subject to change in response to particular circumstances and events and individuals for which intervention may prove beneficial. The system and methodology in accordance with the invention thus provides a substantially real-time system for a business and can provide a tool for increasing productivity and performance of associates of a business.

While the invention has been described in terms of a single preferred embodiment, those skilled in the art will recognize that the invention can be practiced with modification within the spirit and scope of the appended claims.

Having thus described our invention, what we claim as new and desire to secure by Letters Patent is as follows:

1. A method of evaluating likelihood, within a population of persons, that members of said population will respond to encouragement or incentives, said method comprising steps of
identifying a plurality of peer groups within said population, said peer groups being selected to have similar responses to each of a plurality of factors common to said population,
evaluating members of respective peer groups in regard to respective factors of said plurality of factors to obtain a baseline or distribution,
scoring members of said peer group based on the location of the evaluation of a member of a peer group relative to said baseline or distribution for said factors within said peer group to form peer group member scores, and
combining said group member scores and determining likelihood of responsiveness to encouragement or incentives from scores significantly higher or lower than an average or median of group member scores within said peer group.

2. The method as recited in claim 1, including a further step of
applying a standard distribution to said baseline.

3. The method as recited in claim 2, including further steps of
storing said group member scores,
repeating said scoring step to provide a current group member score, and
refining said determining likelihood based on a change between said group member score and said current group member score.

4. The method as recited in claim 3, including further steps of
performing social network analysis to determine influencers and followers within said population, and
overlaying results of said social network analysis on results on said group member scores.

5. The method as recited in claim 4, wherein said population is a population of associates of a business.

6. The method as recited in claim 5, wherein said step of overlaying results is performed by multiplication.

7. The method as recited in claim 4, wherein said step of overlaying results is performed by multiplication.

8. The method as recited in claim 2, including further steps of
performing social network analysis to determine influencers and followers within said population, and
overlaying results of said social network analysis on results on said group member scores.

9. The method as recited in claim 8, wherein said population is a population of associates of a business.

10. The method as recited in claim 9, wherein said step of overlaying results is performed by multiplication.

11. The method as recited in claim 8, wherein said step of overlaying results is performed by multiplication.

12. A method of evaluating likelihood, within a population of persons, that members of said population will respond to encouragement or incentives, said method comprising steps of
configuring a computer to identify a plurality of peer groups within said population, said peer groups being selected to have similar responses to each of a plurality of factors common to said population,
configuring a computer to evaluate members of respective peer groups in regard to respective factors of said plurality of factors to obtain a baseline or distribution,
configuring a computer to score members of said peer group based on the location of the evaluation of a member of a peer group relative to said baseline or distribution for said factors within said peer group to form peer group member scores, and
configuring a computer to combine said group member scores and determining likelihood of responsiveness to encouragement or incentives from scores significantly higher or lower than an average or median of group member scores within said peer group.

13. The method as recited in claim 12, including a further step of
configuring a computer to apply a standard distribution to said baseline.

14. The method as recited in claim 12, including further steps of
configuring a computer to store said group member scores,
configuring a computer to repeat said scoring step to provide a current group member score to refine said determining likelihood based on a change between said group member score and said current group member score.

15. The method as recited in claim 14, including further steps of
configuring a computer to perform social network analysis to determine influencers and followers within said population, and
configuring a computer to overlay results of said social network analysis on results on said group member scores.

16. The method as recited in claim 15, wherein said population is a population of associates of a business.

17. The method as recited in claim 16, wherein said step of overlaying results is performed by multiplication.

18. The method as recited in claim 15, wherein said step of overlaying results is performed by multiplication.
